(19) United States
(12) Patent Application Publication
(10) Pub. No.: US 2008/0258858 A1
(43) Pub. Date: Oct. 23, 2008

(54) Non-burnable varistor

(76) Inventor: Danfeng Sun, Suzhou (CN)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/901,659

(22) Filed: Sep. 18, 2007

(30) Foreign Application Priority Data
Apr. 23, 2007 (CN) 200710021904.2

(51) Int. Cl. H01C 7/10; H01C 17/00; H01C 17/02

(52) U.S. Cl. 338/21; 29/610.1; 29/613; 338/68

(57) ABSTRACT

A non-burnable varistor, comprises a base slice having two opposite surfaces, a first elicit pole electrically connected to one surface of the said base slice, a second elicit pole electrically connected to the other surface of the said base slice. Outside each of the said two opposite surfaces of the base slice a low-melting-point metal conductor layer is respectively situated, which is melted at the temperature of 155˜450° C., and the two layers are not electrically connected by any good conductor. When the non-burnable varistor base is struck and burned through to form an arc, the low-melting-point metal are melted and go into the arc in the form of gas or liquid, to depress the resistance of the arc nearly to a short estate. So the arc current can be cut off by the over-loading security mechanism as over-current protective fuses or breakers, before the coat of the non-burnable varistor caught on fire, to prevent the occurrence of fire accident.

### FIELD OF THE INVENTION

The present invention relates to a kind of varistor (Voltage Dependent Resistor).

### BACKGROUND OF THE INVENTION

Varistors may smoke or catch fire when applied with abnormal overvoltages, sometimes the fire may burn out entire equipment where varistors are installed, and cause huge economic losses. Under the application of abnormal overvoltages, the varistors are not only burnable heat-generating bodies, but also big current-limiting resistors, which prevent over-current protective fuses or breakers in the circuit from cutting off the current flowing through them, and the current will keep on heating varistors until their inside ceramic elements are locally melted and punctured and electric arcs are generated thereof. The arc, usually with a temperature of several thousands of degrees centigrade, may ignite printed circuit boards and plastic coverings of the surrounding components and conducting wires, and hence makes the burning more fierce.

It will take a very short time for varistors to generate arcs once they are applied with abnormal overvoltages with RMS values more than 0.8 times of the varistor voltages, for instance, when the ratio is 1.2˜1.3, a typical arcing time is measured to be 0.2˜0.5 second, so the insulating coating of varistors will not be burned until arcs are generated. Fierce burning always occurs after an arc, Sometimes the arcing current flowing through broken-down varistors can be cut off by the fuses or breakers if their action characteristics happen to be suitable for it. However the acting time of fuses or breakers is usually long enough for arcs to ignite varistor coatings and adjacent components inside the equipment where they are installed and sometimes even the outer cover of the equipment will get burned even if the arcing current can be cut off in this case.

In the prior art, thermal fuses are employed to avoid varistors from catching fire or prevent the fire from spreading (as shown in FIG. 9). The said thermal fuses are used in series connection and thermally coupled with varistors to be protected. when varistors are over-heated by abnormal overvoltages, the heat will be conducted from varistors to thermal fuses which will cut off the current flowing through over-heated varistors if thermal fuses are heated to their melting points, and hence fire accidents are prevented. However, it always takes time for the heat to be conducted from varistors to thermal fuses, in addition, 7˜10 seconds will be taken for thermal fuses to blow after their melting points are reached. For this reason, thermal fuses cannot always blow and cut off the current flowing through over-heated varistors before they catch fire, especially when varistors are applied with relatively high abnormal overvoltages as mentioned above. Practical applications have shown that the use of thermal fuses is effective in fire-prevention of varistors only on condition that the applied abnormal overvoltages are relatively low and varistors are heated slowly.

### SUMMARY OF THE INVENTION

This invention is to provide a non-burnable varistor, which can short-circuit power lines and make over-current protective fuses or breakers cut off the arcing current quickly before its coating is ignited in case abnormal overvoltages occur.

When the non-burnable varistor is burned thoroughly to form an arc under abnormal overvoltages in a short while, the resistivity of the melted base slice gets higher, causing the arc current commonly lower than a level of short circuit current, so the action time of over-current protective fuse or breakers will be long, in most times for several seconds, but the coating of the non-burnable varistor has already been burning before the action of over-current protective fuse or breakers. According to the action principle of the over-current protective fuse or breakers,

Wherein I represents the current flowing through the over-current protective fuse or breakers; t represents the action time, and C represents a constant;

We can acknowledge that the larger the current is, the less time needed to cut off the current is. Therefore, to prevent the non-burnable varistor burning to bring fire accident, the current flowing through the over-current protective fuse or breakers should be enlarged as much as possible.

The technical idea of this invention should be carried out as following:

For the first art, a non-burnable varistor, comprising a base slice including two opposite surfaces, a first elicit pole electrically connected to one surface of the said base slice, and a second elicit pole electrically connected to another surface of the said base slice, wherein on each outside of the said two opposite surfaces, a low-melting-point metal conductor layer is situated, which is melted at the temperature of 155˜450° C., and the two layers are not electrically connected by any good conductor.

According to the first art, both the two opposite surfaces of said base slice are at least partially covered by low-melting-point metal conductor layer which is melted at 155˜450° C.;

The said low-melting-point metal conductor layers are in the form of sheets made of low-melting-point metal, the said sheets covering the said two opposite surfaces of the non-burnable varistor base respectively;

Each of the said low-melting-point metal conductor layers is made of pure stannum, bismuth, indium, plumbum, or alloy containing the substances above-enumerated, wherein stannum or stannum alloy sheet is for the optimal art;

Each of the said first elicit pole and second elicit pole is directly connected to each surface of said base slice respectively, or directly connected to the outside surface of each of said low-melting-point metal conductor layers respectively;

The said low-melting-point metal conductor layer is in the form of a coat containing pure stannum, bismuth, indium, plumbum powder, or alloy powder thereof;

The said coat contains low-melting-point metal powder in weight content of no less than 50%;

The said low-melting-point metal powder is stannum powder or its alloy powder;

Outside of the said base slice is wrapped by insulator wrapping coat, said first elicit pole and second elicit pole drilling through the said insulator wrapping coat and extending outward respectively, said low-melting-point metal conductor layer situated inside the said insulator wrapping coat;

The said insulator wrapping coat is yet covered by another coat made of flame-retardant plastic; and

The said first elicit pole or second elicit pole is welded with elastic metal sheet.

For the second technical art, a non-burnable varistor, comprising a base slice including two opposite surfaces, a first elicit pole electrically connected to one surface of the said base slice, and a second elicit pole electrically connected to the other surface of the said base slice, wherein on each outside surface of the said two opposite surfaces, a low-melting-point metal conductor layer is situated, which is melted at the temperature of 155˜450° C.; an insulator film is located between the said low-melting-point metal conductor layer and the said first elicit pole; another insulator film is located between the said low-melting-point metal conductor layer and the said second elicit pole, to make the said low-melting-point metal conductor layer and the said first elicit pole insulated, and the said low-melting-point metal conductor layer and the said second elicit pole insulated.

According to the second technical art, the said low-melting-point metal conductor layer is a film made of pure metal power enumerated as stannum, bismuth, indium, and plumbum, or alloy powder thereof, stannum powder or its alloy powder being preferred;

The said film contains low-melting-point metal powder in weight content of no less than 50%;

The said base slice of the non-burnable varistor is wrapped by insulator wrapping coat, the said first elicit pole and second elicit pole each drilling through the said insulator wrapping coat and extending outward, with said low-melting-point metal conductor layer situated inside the said insulator wrapping coat;

The said insulator wrapping coat is yet covered by another coat made of flame-resistant plastic; and

On the said first elicit pole or second elicit pole is welded with elastic metal sheet.

For the third technical art, the production method of a non-burnable varistor, including steps described as below:

Directly connect one end of a first elicit pole and a second elicit pole to the two opposite surfaces of the base slice of the non-burnable varistor respectively; then

Paste two low-melting-point metal sheets onto the two opposite surfaces of the base slice respectively to make them at least partially cover the said surfaces forming low-melting-point metal conductor layers.

According to the third technical art, after step (2), wrap insulating material onto the outside surface of the base slice and the low-melting-point metal sheet, to form an insulator wrapping coat.

For the fourth technical art, the production method of a non-burnable varistor, including steps described as below:

Directly connect one end of a first elicit pole and a second elicit pole to the two opposite surfaces of the base slice of the non-burnable varistor respectively; then

Smear low-melting-point metal paint onto the said two opposite surfaces of the base slice to form a low-melting-point metal film.

After step (2), according to the fourth technical art, wrap insulating material onto the outside surface of the said base slice and onto the outside surface of the low-melting-point metal film, to form an insulator wrapping coat.

For the fifth technical art, the production method of a non-burnable varistor, including steps described as below:

Directly connect one end of a first elicit pole and a second elicit pole to the two opposite surfaces of the base slice of the non-burnable varistor respectively;

Smear insulating material on the outside surface of the base slice to form the insulator film thereon; and then

Smear low-melting-point metal paint onto the outside surface of the said insulator film to form a low-melting-point metal film.

After step (3), according to the fifth technical art, wrap insulating material onto the outside surface of the low-melting-point metal film, to form a insulator wrapping coat.

For the sixth technical art, the production method of a non-burnable varistor, including steps described as below:

Paste two low-melting-point metal sheets onto the two opposite surfaces of the base slice of the non-burnable varistor respectively to make them at least partially cover the said opposite surfaces, to form a low-melting-point metal conductor layer; and then

Weld one end of the said first elicit pole and second elicit pole to the low-melting-point metal sheets respectively.

After step (2), wrap insulating material onto the outside surface of the said low-melting-point metal conductor layer, to form an insulator wrapping coat.

Comparing to the prior art, this invention has the advantages as: due to the low-melting-point metal conductor layers, when the base slice of the non-burnable varistor is struck and burned through to form an arc, the low-melting-point metal are melted and come into the arc in the form of gas or liquid, depressing the arc resistance nearly to a level of short estate, and the arc current approaching the value of short-circuit correspondingly, to make the arc current be cut off by over-current protective fuse or breakers, before the coat of the non-burnable varistor caught on fire, in order to avoid fire accident.

### BRIEF DESCRIPTION OF THE DRAWINGS

In order to make this invention more readily understood and carried out, references will now be made to the accompanying drawings, which illustrate preferred embodiments of the invention, wherein:

FIG. 1 is the front view of the invention;

FIG. 2 is the back view of the invention;

FIG. 3 is a cross-sectional view of FIG. 1 according to the line A-A for the first embodiment;

FIG. 4 is a cross-sectional view of FIG. 1 according to the line A-A for the second embodiment;

FIG. 5 is a cross-sectional view of FIG. 1 according to the line A-A for the third embodiment;

FIG. 6 is a cross-sectional view of FIG. 1 according to the line A-A for the fourth embodiment;

FIG. 7 is a schematic view of the structure of the invention according to the fifth embodiment;

FIG. 8 is a schematic view of the structure of the invention according to the sixth embodiment;

FIG. 9 is a circuit diagram utilized in the non-burnable varistor and temperature fuse according to the prior art;

FIG. 10 is a schematic view of the non-burnable varistor in the state of being stuck through according to this invention;

FIG. 11 is a circuit diagram utilized in this invention according to the sixth embodiment;

FIG. 12 is a schematic view of the structure of this invention according to the seventh embodiment; and

FIG. 13 is a cross-sectional view of FIG. 12 along the line B-B;

Wherein: 1 non-burnable varistor base; 2 the first elicit pole; 3 the second elicit pole; 4 insulator wrapping coat; 5 low-melting-point metal conductor layer; 6 insulator film; 7 coat; 8 elastic metal sheet; 9 guarantied equipment; 10 non-burnable varistor; 11 over-current protective fuse; 12 surface; 13 surface; 14 low-melting-point metal sheet; 15 low-melting-point metal film; 16 temperature fuse; 17 hole; and 18 spring; are respectively represented.

### DESCRIPTION OF SEVERAL PREFERRED EMBODIMENTS OF THIS INVENTION

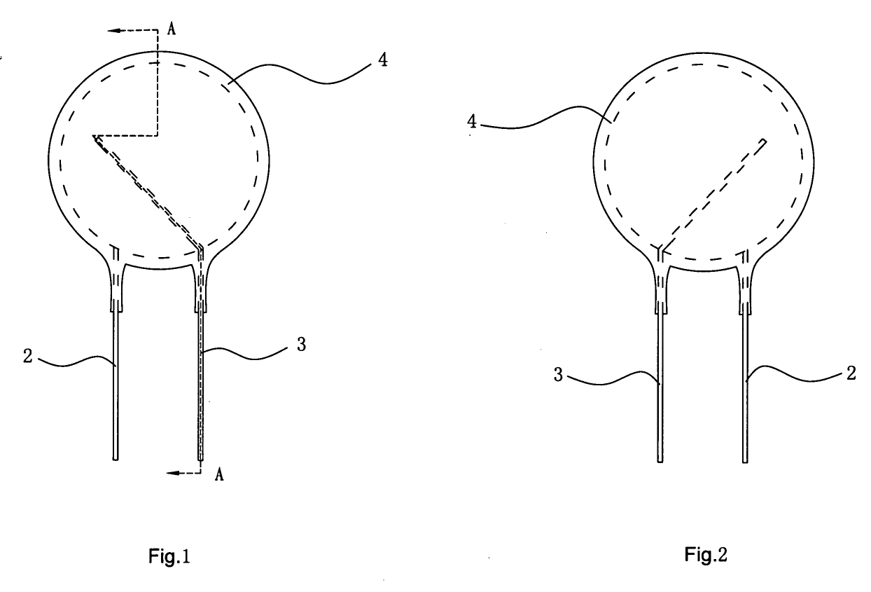

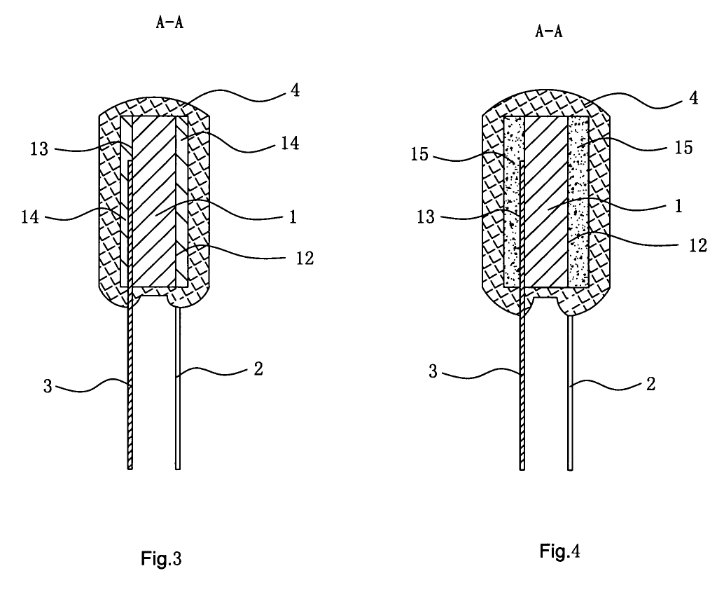

The first embodiment provides a non-burnable varistor as shown in FIG. 1 to FIG. 3, comprising a base slice 1 including two opposite surfaces 12 and 13, a first elicit pole 2 directly connected to one surface 12 of the said base slice 1, a second elicit pole 3 directly connected to the other surface 13 of the said base slice 1. On each outside surface of the said two opposite surfaces, a low-melting-point metal sheet 14, which is melted at the temperature of 155˜450° C., such as stannum sheet, stannum alloy sheet, etc, is situated. The said two metal sheets 14 are not electrically connected by any good conductor.

The base slice 1 of said non-burnable varistor is wrapped by insulator wrapping coat 4, the said first elicit pole 2 and second elicit pole 3 drilling through the said insulator wrapping coat 4 and extending outward respectively. The said low-melting-point metal conductor layer 5 is situated inside the said insulator wrapping coat 4.

The said non-burnable varistor can be produced by the method described as below:

Directly weld one end of the said first elicit pole 2 and second elicit pole 3 to the two opposite surfaces 12 and 13 of the base slice 1 respectively;

Paste two low-melting-point metal sheets 14 (such as pure stannum sheet, Sn—Cu alloy sheet, Sn—Pb alloy sheet, etc.) with the same diameter as the base slice 1 and a thickness of 0.1 mm˜0.4 mm onto the two opposite surfaces 12 and 13 of the base slice 1 by glue gelatinization or tin soldering respectively to form a low-melting-point metal conductor layer 5.

After the said step (2), wrap insulating material onto the side surface of said base slice 1 and the outside surface of the low-melting-point metal sheets 14, to form an insulator wrapping coat 4, and envelope them according to the demand of size, shape, insulation and pressure resistance, to form a non-burnable varistor. The said insulating material is usually epoxy resin coating material or silicone resin or Bakelite coating material.

As shown in FIG. 10, when the action character of the overloading guaranty breakers in the circuit under abnormally high voltage is able to cut off the arc current, and the ratio of effective value of the abnormally high voltage and the pressure-sensitive voltage is larger than 0.8, the base slice 1 has several holes 17 after being struck through and form an arc. The low-melting-point metal sheets 14 on the surfaces 12 and 13 of the base slice 1 are melted and come into the holes 17 in the form of gas or liquid, depressing the arc resistance nearly to a level of short-circuit estate quickly with a value of no more than 0.01Ω, and the arc current correspondingly approaches the short-circuit value at the same time. So the arc current can be cut off by over-current protective fuse or breakers, before the coat of the non-burnable varistor caught on fire, to prevent the occurrence of fire accident.

The second embodiment provides a non-burnable varistor as shown in FIG. 4, comprising a non-burnable varistor base 1 including two opposite surfaces 12 and 13, a first elicit pole 2 directly connected to one surface 12 of the said base 1, and a second elicit pole 3 directly connected to the other surface 13 of the said base 1. On each outside surface of the said two opposite surfaces 12 and 13, a low-melting-point metal conductor layer 5 is situated, which is melted at the temperature of 155˜450° C. The two layers 5 on the two sides are not electrically connected by any good conductor. Each said low-melting-point metal conductor layer 5 is made of glue or paint containing low-melting-point metal powder, (such as pure stannum, Sn—Cu alloy, Sn—Pb alloy, etc.) in weight content of more than 50%.

The said non-burnable varistor base 1 is wrapped by insulator wrapping coat 4, said first elicit pole 2 and second elicit pole 3 drilling through the said insulator wrapping coat 4 and extending outward respectively. The said low-melting-point metal conductor layer 5 is situated inside the said insulator wrapping coat 4.

The said non-burnable varistor can be produced by the method described as below:

Directly weld one end of the said first elicit pole 2 and second elicit pole 3 to the two opposite surfaces 12 and 13 of the said base slice 1 respectively; and then

Smear the glue or paint containing over 50 wt % low-melting-point metal powder such as pure stannum powder, Sn—Cu alloy powder, Sn—Pb alloy powder, etc. onto the two opposite surfaces 12 and 13 of the base slice 1, at a thickness of 0.1 mm˜0.4 mm to form a low-melting-point metal conductor layer 15, which covers the end surfaces of the base slice 1 completely, but not covers the side surfaces of the base slice 1.

After step (2), wrap insulating material onto the outside surface of the said base slice 1 and of the low-melting-point metal film 15, to form an insulator wrapping coat 4. Envelope them according to the demand of size, shape, insulation and pressure resistance to form a non-burnable varistor. The insulating material is usually epoxy resin coating material or silicone resin or Bakelite coating material.

As shown in FIG. 10, when the action character of the overloading guaranty mechanism in the circuit under abnormally high voltage, is able to cut off the arc current, and the ratio of the effective value of the abnormally high voltage and pressure-sensitive voltage is larger than 0.8, the base slice 1 has several holes 17 after being struck through and form an arc. The low-melting-point metal films 15 on the surfaces 12 and 13 of the base slice 1 are melted and come into the holes 17 in the form of gas or liquid, depressing the arc resistance nearly to a level of short-circuit quickly with resistance value of no more than 0.01Ω, and the arc current correspondingly approaches the short-circuit value at the same time. So the arc current can be cut off by over-current protective fuse or breakers, before the coat of the non-burnable varistor caught on fire, to prevent the occurrence of fire accident.

The third embodiment provides a non-burnable varistor as shown in FIG. 5, comprising a base slice 1 including two opposite surfaces 12 and 13, a first elicit pole 2 directly connected to one surface 12 of the said base slice 1, and a second elicit pole 3 directly connected to the other surface 13 of the said base slice 1. On each outside surface of the said two opposite surfaces 12 and 13, a low-melting-point metal conductor layer 5 is situated, which is melted at the temperature of 155˜450° C. An insulator film 6 is located between the said low-melting-point metal conductor layer 5 and the said first elicit pole 2; and another insulator film 6 is located between the said low-melting-point metal conductor layer 5 and the said second elicit pole 3. So the said low-melting-point metal conductor layer 5 and the said first elicit pole 2 are insulated; and the said low-melting-point metal conductor layer 5 and the said second elicit pole 3 are insulated. The said low-melting-point metal conductor layer 5 is made of glue or paint containing low-melting-point metal powder such as pure stannum, Sn—Cu alloy, and Sn—Pb alloy, etc. in the weight content of more than 50%.

The said non-burnable varistor base 1 is wrapped by insulator wrapping coat 4, said first elicit pole 2 and second elicit pole 3 drilling through the said insulator wrapping coat 4 and extending outward respectively. Said low-melting-point metal conductor layer 5 is situated inside the said insulator wrapping coat 4.

The said non-burnable varistor provided by the third embodiment can be produced by the method described as below:

Directly weld one end of the said first elicit pole 2 and second elicit pole 3 to the two opposite surfaces 12 and 13 of the base slice 1 respectively; then

Smear the insulating material such as epoxy resin in the form of liquid or power, insulated varnish, or another onto the outside surface of the base slice 1 to form an insulator film 6, with a thickness of no more than 0.2 mm; and then

Smear the glue or paint containing over 50 wt % low-melting-point metal powder onto the outside surface of the insulating film 6 to form a low-melting-point metal film 15.

After step (3), wrap insulating material onto the outside surface of the said base slice 1 and of the low-melting-point metal sheets 14, to form an insulator wrapping coat 4. Envelope them according to the demand of size, shape, insulation and pressure resistance to form a non-burnable varistor. The insulating material is usually epoxy resin coating material or silicone resin or Bakelite coating material.

As shown in FIG. 10, when the action character of the overloading guaranty mechanism in the circuit under abnormally high voltage, is able to cut off the arc current, and the ratio of the effective value of the abnormally high voltage and pressure-sensitive voltage is larger than 0.8, the base slice 1 has several holes 17 after being struck through and form an arc. The low-melting-point metal films 15 on the surfaces 12 and 13 of the base slice 1 are melted and come into the holes 17 in the form of gas or liquid, depressing the arc resistance nearly to a level of short-circuit quickly with resistance value of no more than 0.01Ω, and the arc current approaches the short-circuit value correspondingly at the same time. So the arc current can be cut off by over-current protective fuse or breakers, before the coat of the non-burnable varistor caught on fire, to prevent the occurrence of fire accident.

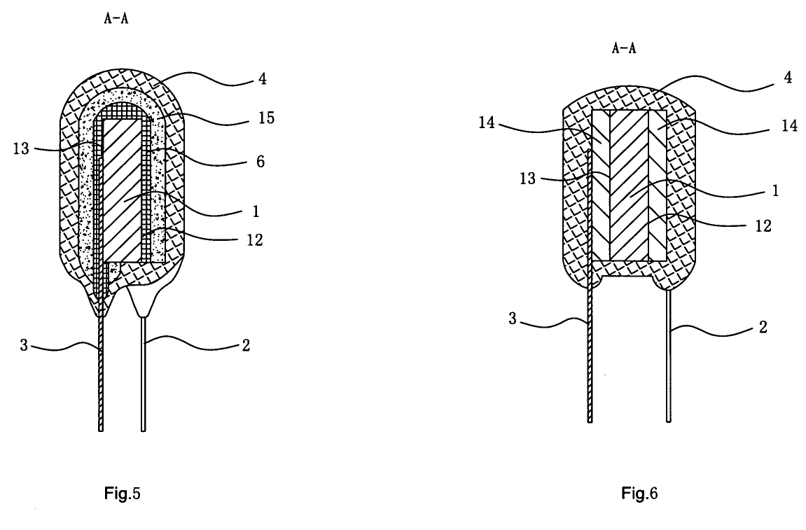

The fourth embodiment provides a non-burnable varistor as shown in FIG. 6, comprising a base slice 1 including two opposite surfaces 12 and 13, a first elicit pole 2 electrically connected to one surface 12 of the said base slice 1, a second elicit pole 3 electrically connected to the other surface 13 of the said base slice 1. On each outside surface of the said two opposite surfaces 12 and 13, a low-melting-point metal sheet 14 such as stannum sheet, or stannum alloy sheet, etc) is situated, which is melted at the temperature of 155˜450° C. And the two sheets 14 on the two sides are not electrically connected by any good conductor. One end of the said first elicit pole 2 and of second elicit pole 3 is welded onto the said low-melting-point metal sheets 14 respectively.

The said base slice 1 is wrapped by insulator wrapping coat 4, the said first elicit pole 2 and second elicit pole 3 drilling through the said insulator wrapping coat 4 and extending outward respectively. The said low-melting-point metal conductor layer 5, is situated inside the said insulator wrapping coat 4.

The above-described non-burnable varistor can be produced by the method described as below:

Paste two low-melting-point metal sheets 14 melted under the temperature of 155˜450° C. such as pure stannum sheet, Sn—Cu alloy sheet, Sn—Pb alloy sheet, etc. with the same diameter as the base slice 1 and a thickness of 0.1 mm˜0.4 mm onto the two opposite surfaces 12 and 13 of the base slice 1 respectively to form low-melting-point metal conductor layer 5; and then

Press one end of the said first elicit pole 2 and second elicit pole 3 tightly onto the two opposite surfaces 12 and 13 of the base slice 1 respectively, and immerge them together into melted soldering tin to weld the end of the first elicit pole 2 and second elicit pole 3 to the said metal sheets 14 respectively while there is welding flux on the low-melting-point metal sheets 14 and the end of the first elicit pole 2 and of the second elicit pole 3. The welding temperature is no larger than the melting point of the metal sheet 14, and the welding time is 1˜5 seconds.

After step (2), wrap insulating material onto the outside surface of the said base slice 1 and the low-melting-point metal sheets 14, to form the insulator wrapping coat 4, and then envelope them according to the demand of size, shape, insulation and pressure resistance to form non-burnable varistor. The referred insulating material is usually epoxy resin coating material or silicone resin or Bakelite coating material.

As shown in FIG. 10, under abnormally high voltage, when the action character of the overloading guaranty mechanism in the circuit is able to cut off the arc current, and the ratio of the effective value of the abnormally high voltage and pressure-sensitive voltage is larger than 0.8, the base slice 1 has several holes 17 after being struck through to form an arc. The low-melting-point metal sheets 14 on the surfaces 12 and 13 of the base slice 1 are melted and come into the holes 17 in the form of gas or liquid, quickly depressing the arc resistance nearly to a level of short-circuit with a resistance value of no more than 0.01Ω, and the arc current approaches the short-circuit value correspondingly at the same time. So the arc current can be cut off by over-current protective fuses or breakers, before the coat of the non-burnable varistor caught on fire, in order to avoid occurrence of fire accident.

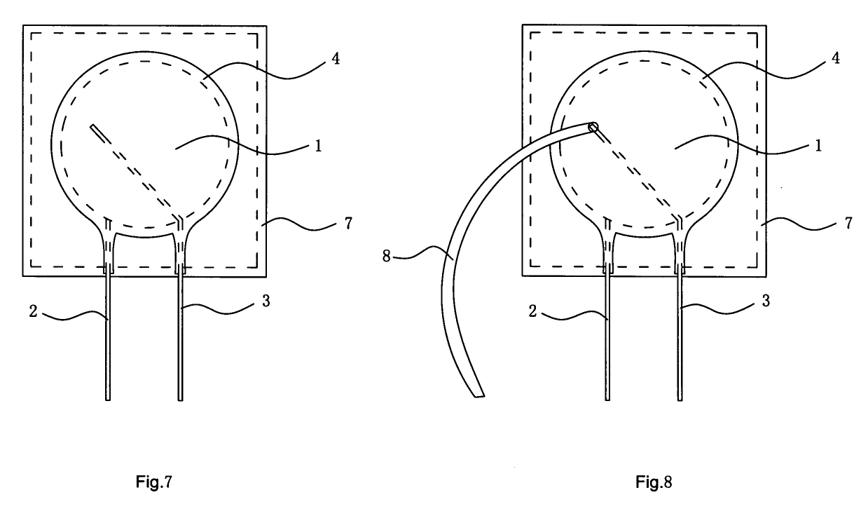

In the fifth embodiment as shown in FIG. 7, a coat 7 made of burn blocking plastic or a pyrocondensation bushing is added outside the non-burnable varistor pre-mentioned in the above four embodiments, to prevent the spilling of melted metal causing short-circuit of surrounding parts while the arc current is large.

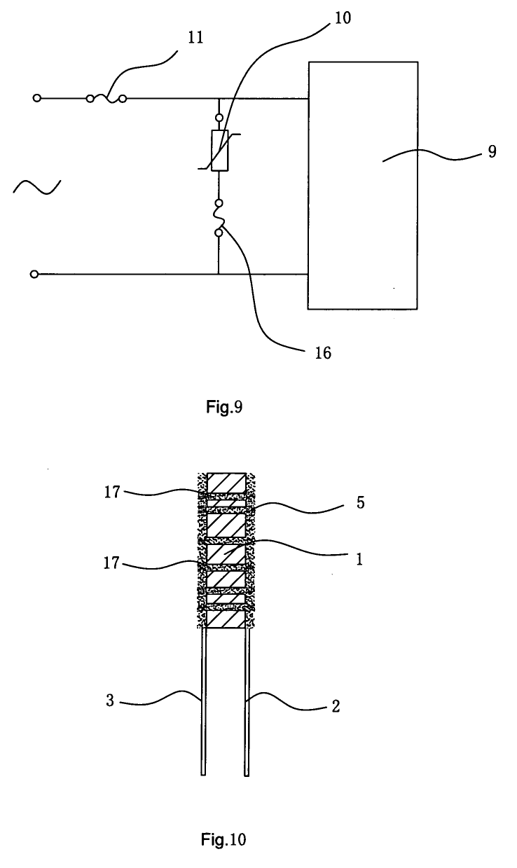

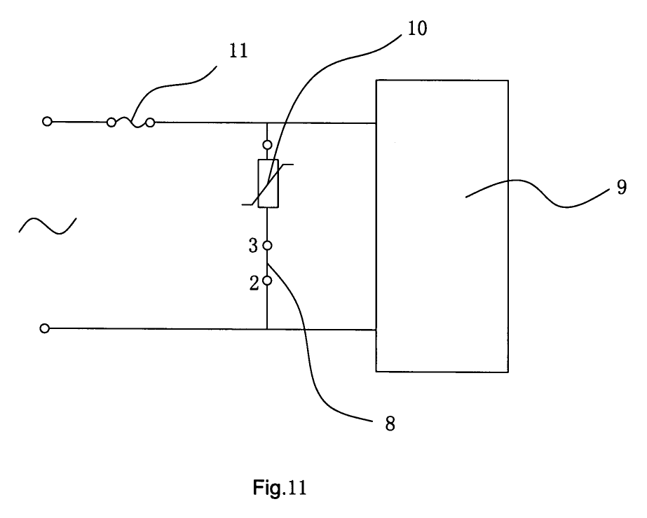

In the sixth embodiment as shown in FIG. 8, one end of an elicit pole of the non-burnable varistor according to the above five embodiments, bends until being perpendicular to the plate of the base slice 1, after drilling through the insulator wrapping coat 4. The part outside the insulator wrapping coat is connected to a good-conducting elastic metal such as beryllium bronze sheet 8 by low-temperature tin soldering with a melting point of no larger than 140° C. This design maintained all the functions of the upper described five embodiments, and the additional good-conducting elastic metal sheet 8 can pop up and cut off the current when the non-burnable varistor heats slowly, as the temperature fuses do. Besides, as shown in FIG. 9, normally end 2 and end 3 are in short-circuit state, and have no potential difference, while the additional good-conducting elastic metal sheet 8 pop up and cut off the current, a potential difference appears between end 2 and end 3, therefore can send an error signal.

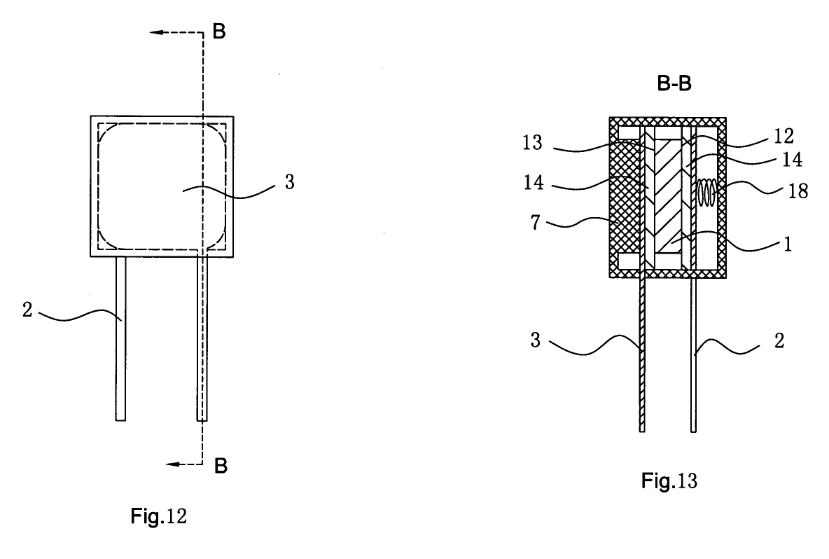

The seventh embodiment provides a non-burnable varistor as shown in FIG. 12 and FIG. 13, comprising a base slice 1 including two opposite surfaces 12 and 13, a first elicit pole 2 electrically connected to one surface 12 of the said base slice 1, and a second elicit pole 3 electrically connected to the other surface 13 of the said base slice 1. On each outside surface of the said two opposite surfaces 12 and 13, a low-melting-point metal sheet 14 such as stannum sheet, stannum alloy sheet, etc. is situated, which is melted at the temperature of 155˜450° C. And the two sheets 14 on the two sides are not electrically connected by any good conductor. The said low-melting-point metal sheet 14 has a diameter 0.5˜2.0 mm larger than the said base slice 1. One end of the said first elicit pole 2 and second elicit pole 3 is welded onto the said low-melting-point metal sheets 14 respectively. Outside the structure as pre-described, a coat made of burn blocking plastic is added to prevent the spilling of melted metal causing short-circuit of surrounding parts while arc current is large. Between one surface 12 of the said base slice 1 and one side surface of the coat 7, a string 18 is situated to press the low-melting-point metal sheet 14 tightly onto the surface 12 of the base slice 1. One end of the said first elicit pole 2 and second elicit pole 3 drill through the coat 7 and extend outward.

As shown in FIG. 10, when the action character of the overloading guaranty mechanism in the circuit, under abnormally high voltage, is able to cut off the arc current, and the ratio of the effective value of the abnormally high voltage and pressure-sensitive voltage is larger than 0.8, the base slice 1 has several holes 17 after being struck through to form an arc. Due to the diameter of the low-melting-point metal sheets 14 is 0.5˜2.0 mm larger than the diameter of the base slice 1, when the non-burnable varistor heats slowly, the low-melting-point metal sheets 14 are melted and form a reliable short-circuit on the side surface of the base slice 1, therefore transforming the current in the base slice 1 to the metal on the side surface, to prevent the base slice 1 being continuously heated and the occurrence of fire accident.

1. A non-burnable varistor, comprising:
A base slice (1), having two opposite surfaces (12, 13);
A first elicit pole (2), electrically connected to one surface (12) of the said base slice (1); and
A second elicit pole (3), electrically connected to the other surface (13) of the said base slice (1); is characterized in that:
On each outside surface of the said two opposite surfaces (12, 13), a low-melting-point metal conductor layer (5) is situated respectively, which is melted at the temperature of 155˜450° C., and the two layers (5) are not electrically connected by any good conductor.

2. The non-burnable varistor according to claim 1, is characterized in that both the two opposite surfaces (12, 13) of said base slice (1) are at least partially covered by low-melting-point metal conductor layers (5) which are melted at a temperature of 155˜450° C.

3. The non-burnable varistor according to claim 2, is characterized in that the brim of at least one low-melting-point metal conductor layer (5) extends out of the brim of the said base slice (1).

4. The non-burnable varistor according to claim 3, is characterized in that the brim of both the two low-melting-point metal conductor layers (5) extend out the brim of the said non-burnable varistor base (1) of 0.5˜2.0 mm.

5. The non-burnable varistor according to claim 1 and 2, is characterized in that the said low-melting-point metal conductor layers (5) are metal sheets made of low-melting-point metal, the said metal sheets covering the said two opposite surfaces (12, 13) of the said base slice (1) respectively.

6. The non-burnable varistor according to claim 5, is characterized in that the said low-melting-point metal conductor layer (5) is metal sheet made of pure stannum, bismuth, indium, plumbum, or alloy of them.

7. The non-burnable varistor according to claim 6, is characterized in that the said low-melting-point metal conductor layer (5) is stannum sheet or stannum alloy sheet.

8. The non-burnable varistor according to claim 1 and 2, is characterized in that one end of said first elicit pole (2) and of the second elicit pole (3) is directly connected to the surfaces (12, 13) of the base slice (1), or directly connected to the outside surfaces of said low-melting-point metal conductor layers (5).

9. The non-burnable varistor according to claim 1, is characterized in that the said low-melting-point metal conductor layer (5) is a film containing pure stannum, bismuth, indium, or plumbum powder, or alloy powder thereof.

10. The non-burnable varistor according to claim 9, is characterized in that the said film contains no less than 50 wt % low-melting-point metal powder.

11. The non-burnable varistor according to claim 9, is characterized in that the said low-melting-point metal powder is stannum powder or its alloy powder.

12. The non-burnable varistor according to claim 1, is characterized in that the said base slice (1) is wrapped by insulator wrapping coat (4), with the said low-melting-point metal conductor layer (5) situated inside the said insulator wrapping coat (4), the said first elicit pole (2) and second elicit pole (3) drilling through the said insulator wrapping coat (4) and extending outward respectively.

13. The non-burnable varistor according to claim 1, is characterized in that the said insulator wrapping coat (4) is yet covered by another coat (7) made of flame-resistant plastic.

14. The non-burnable varistor according to claim 1, is characterized in that the said first elicit pole (2) or second elicit pole (3) is welded with an elastic metal sheet (8).

15. A non-burnable varistor, comprising:
A base slice (1), including two opposite surfaces (12, 13);
A first elicit pole (2), electrically connected to one surface (12) of the said base slice (1); and
A second elicit pole (3) electrically connected to the other surface (13) of the said base slice (1); is characterized in that:
On each outside surface of the said two opposite surfaces (12, 13), a low-melting-point metal conductor layer (5) is situated respectively, which is melted at a temperature of 155˜450° C., along with an insulator film (6) located between the said low-melting-point metal conductor layer (5) and the said first elicit pole (2), making the said low-melting-point metal conductor layer (5) and the said first elicit pole (2) insulated; and another insulator film (6) located between the said low-melting-point metal conductor layer (5) and the said second elicit pole (3), making the said low-melting-point metal conductor layer (5) and the said second elicit pole (3) insulated.

16. The non-burnable varistor according to claim 15, is characterized in that the said low-melting-point metal conductor layer (5) is a film containing pure stannum, bismuth, indium, plumbum powder, or alloy powder thereof.

17. The non-burnable varistor according to claim 16, is characterized in that the said film contains no less than 50 wt % low-melting-point metal powder.

18. The non-burnable varistor according to claim 17, is characterized in that the said low-melting-point metal powder is stannum powder or its alloy powder.

19. The non-burnable varistor according to claim 15, is characterized in that the said base slice (1) is wrapped by insulator wrapping coat (4), with said low-melting-point metal conductor layer (5) situated inside the said insulator wrapping coat (4), the said first elicit pole (2) and second elicit pole (3) drilling through the said insulator wrapping coat (4) and extending outward respectively.

20. The non-burnable varistor according to claim 15, is characterized in that the said insulator wrapping coat (4) is yet covered by another coat (7) made of flame-retardant plastic.

21. The non-burnable varistor according to claim 15, is characterized in that the said first elicit pole (2) or second elicit pole (3) is welded with an elastic metal sheet (8).

22. A production method of the non-burnable varistor, is characterized in that it comprises steps described as below:
(1) Directly connect one end of the said first elicit pole (2) and second elicit pole (3) to the two opposite surfaces (12, 13) of the base slice (1) respectively; and then
(2) Paste two low-melting-point metal sheets (14) onto the two opposite surfaces (12, 13) of the base slice (1) respectively and make them at least partially cover the said surfaces.

23. The production method of a non-burnable varistor according to claim 22, is characterized in that after step (2), wrap insulating material onto the outside surface of the said base slice (1) and the low-melting-point metal sheet (14), to form an insulator wrapping coat (4).

24. A production method of the non-burnable varistor, is characterized in that it includes steps described as below:
(1) Directly connect one end of the said first elicit pole (2) and second elicit pole (3) to the two opposite surfaces (12, 13) of the base slice (1) respectively; and then
(2) Smear low-melting-point metal paint on the said two opposite surfaces (12, 13) of the base slice (1) to form a low-melting-point metal film (15).

25. The production method of the non-burnable varistor according to claim 24, is characterized in that after step (2), wrap insulating material onto the outside surface of the said base slice (1) and the low-melting-point metal film (15), to form an insulator wrapping coat (4).

26. A production method of the non-burnable varistor, is characterized in that it includes steps described as below:
(1) Directly connect one end of the said first elicit pole (2) and second elicit pole (3) to the two opposite surfaces (12, 13) of the base slice (1) respectively; then
(2) Smear insulating material on the outside surface of the base slice (1) to form an insulator film (6); and then
(3) Smear low-melting-point metal paint onto the outside surface of the said insulator film (6) to form a low-melting-point metal film (15).

27. The production method of the non-burnable varistor according to claim 26, is characterized that after step (3), wrap insulating material onto the outside surface of the said base slice (1) and the low-melting-point metal film (15), to form an insulator wrapping coat (4).

28. A production method of the non-burnable varistor, is characterized in that it includes steps described as below:
(1) Paste two low-melting-point metal sheets (14) onto the two opposite surfaces (12, 13) of the base slice (1) respectively and make them at least partially cover the said surfaces, to form a low-melting-point metal conductor layer (5); and then
(2) Weld one end of the said first elicit pole (2) and second elicit pole (3) to the low-melting-point metal sheets (14) respectively.

29. The production method of a non-burnable varistor according to claim 28, is characterized in that after step (2), wrap insulating material onto the outside surface of the low-melting-point metal conductor layer (5), to form an insulator wrapping coat (4).
